(19) United States
(12) Patent Application Publication
(10) Pub. No.: US 2012/0150753 A1
(43) Pub. Date: Jun. 14, 2012

(54) QUANTITATIVE VALUATION OF REAL ESTATE BASED ON QUALITATIVE ASSESSMENT THEREOF

(76) Inventor: Nathan Collins, New York, NY (US)

(21) Appl. No.: 13/314,308

(22) Filed: Dec. 8, 2011

Related U.S. Application Data
(60) Provisional application No. 61/420,970, filed on Dec. 8, 2010.

(51) Int. Cl. G06Q 50/16

(52) U.S. Cl. 705/306; 705/313

(57) ABSTRACT

Quantitative assessment of real estate property is provided, wherein a qualitative assessment of a subject property as compared to a comparison property is obtained from a user. The qualitative assessment includes qualitative comparisons of the subject property to the comparison property across comparison criteria, and a qualitative assessment is determined based on the qualitative assessment, by translating the qualitative comparisons into quantitative comparisons of the subject property to the comparison property, to obtain at least one numerical value, and then determining an overall attractiveness score based on the obtained at least one numerical value. In further aspects, aggregate and predictive quantitative assessments of the subject property, as well as an estimated transaction value of the subject property, can be determined.

### CROSS-REFERENCE TO RELATED APPLICATIONS

This application claims the benefit of U.S. Provisional Patent Application Ser. No. 61/420,970, filed Dec. 8, 2010, the contents of which are hereby incorporated herein by reference in its entirety.

### TECHNICAL FIELD

This invention relates to real estate assessment and more particularly to collecting and manipulating qualitative opinions of value of real estate properties and quantitative real estate data and property transactions, and extracting quantitative values based on the cumulative qualitative opinions of value, quantitative real estate data and real estate property transactions.

### BACKGROUND OF THE INVENTION

Real estate value is primarily determined by value of competitive properties (sometimes referred to as “comps”) in the marketplace. For example, an old building in a desirable neighborhood with very valuable competitors may be more valuable than a new building in a less desirable neighborhood with less valuable competitors. Historically, the only way to know how a specific building in a market was positioned with respect to its competitors was to gain an in-depth knowledge of the market through years of investigation, or by obtaining the opinions of professionals within the market. This is not an easy task. The real estate industry is not a transparent market. The industry is highly fragmented by a large number of professionals working in many small firms and having knowledge of different transactions, properties and markets. Except for data regarding property sales and other data required by tax records, transaction information and property information is not recorded by a public agency and does not reside in a centralized private database. Although estimates of the relative value of a property may be gained by obtaining specific transaction information from local professionals, these methods can be time consuming and require strong relationships with such local professionals. Moreover, the methods are susceptible to influence from subjective opinions and incomplete knowledge by the limited number of professionals with which a relationship is formed.

### BRIEF SUMMARY OF THE INVENTION

The shortcomings of the prior art are overcome and additional advantages are provided through the provision of a method for providing quantitative assessment of real estate property. The method includes, for instance, obtaining from a user, by a data processing system, a qualitative assessment of a subject property as compared to a comparison property via a user interface provided by the data processing system, the qualitative assessment including at least one qualitative comparison of the subject property to the comparison property for at least one comparison criteria, and determining, based on the obtained qualitative assessment, a quantitative assessment of the subject property as compared to the comparison property, the quantitative assessment including an overall attractiveness score of the subject property as compared to the comparison property, and the determining including translating the at least one qualitative comparison into at least one quantitative comparison of the subject property to the comparison property, to obtain at least one numerical value, and determining the overall attractiveness score based on the obtained at least one numerical value.

In a further aspect of the present invention, a computer system is provided for providing quantitative assessment of real estate property. The computer system includes, for instance, a memory and a processor, the processor in communications with the memory, wherein the computer system is configured to perform a method which includes obtaining from a user, by the computer system, a qualitative assessment of a subject property as compared to a comparison property via a user interface provided by the computer system, the qualitative assessment including at least one qualitative comparison of the subject property to the comparison property for at least one comparison criteria, and determining, based on the obtained qualitative assessment, a quantitative assessment of the subject property as compared to the comparison property, the quantitative assessment including an overall attractiveness score of the subject property as compared to the comparison property, and the determining including translating the at least one qualitative comparison into at least one quantitative comparison of the subject property to the comparison property, to obtain at least one numerical value, and determining the overall attractiveness score based on the obtained at least one numerical value.

In yet a further aspect of the present invention, a computer program product is provided for providing quantitative assessment of real estate property. The computer program product includes, for instance, a tangible storage medium readable by a processor and storing instructions for execution by the processor to perform a method which includes obtaining from a user, by a data processing system, a qualitative assessment of a subject property as compared to a comparison property via a user interface provided by the data processing system, the qualitative assessment including at least one qualitative comparison of the subject property to the comparison property for at least one comparison criteria, and determining, based on the obtained qualitative assessment, a quantitative assessment of the subject property as compared to the comparison property, the quantitative assessment including an overall attractiveness score of the subject property as compared to the comparison property, and the determining including translating the at least one qualitative comparison into at least one quantitative comparison of the subject property to the comparison property, to obtain at least one numerical value, and determining the overall attractiveness score based on the obtained at least one numerical value.

Additional features and advantages are realized through the concepts of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts an example of a data processing system for facilitating one or more aspect of the present invention;

FIG. 2 depicts an overview of an architecture for facilitating one or more aspects of the present invention;

FIG. 3 depicts one example of a process for providing a quantitative assessment of a subject real estate property, in accordance with one or more aspects of the present invention;

FIG. 4 depicts one example of a process for determining an aggregate quantitative assessment of a subject property, in accordance with one or more aspects of the present invention;

FIG. 5 depicts an example of a process for determining a predictive quantitative assessment for a subject property, in accordance with one or more aspects of the present invention;

FIG. 6A depicts one example of a process for valuing a subject property, in accordance with one or more aspects of the present invention;

FIG. 6B depicts another example of a process for valuing a subject property, in accordance with one or more aspects of the present invention;

FIG. 7 depicts one example of a process for determining a predicted common property metric value for a subject property, in accordance with one or more aspects of the present invention;

FIG. 8 depicts one example of a process for retrieving a property for comparison, in accordance with one or more aspects of the present invention; and

FIG. 9 depicts one embodiment of a computer program product incorporating one or more aspects of the present invention.

### DETAILED DESCRIPTION

Aspects of the present invention relate to provision of opinions of value for real estate, for instance over a web connection, such as the Internet. A system is be provided which facilitates transforming qualitative comparisons made across comparison criteria into quantitative values, in order to create rankings of properties and to analyze other quantitative data associated with those properties. The system can determine a qualitative and quantitative value of a real estate property by providing users with a subsystem that users can use to compare, using qualitative criteria, real estate properties that have been identified in the system, for instance uploaded onto the system by users or by an administrator. The subsystem can breakdown and present how properties in the system compare on a qualitative and quantitative basis to a subject property. As used herein, a comparison property being compared to the subject property can include a competitive property, or “comp” in the marketplace, the value of which can provide an indication of the value of the subject property. The system can also include a subsystem for analyzing property data, including but not limited to lease and sale data, which has been uploaded by users or provided by third-party agencies, in order to determine values or make projections on other properties in the system. This is facilitated using a breakdown of property comparisons, property data, and a set of algorithms.

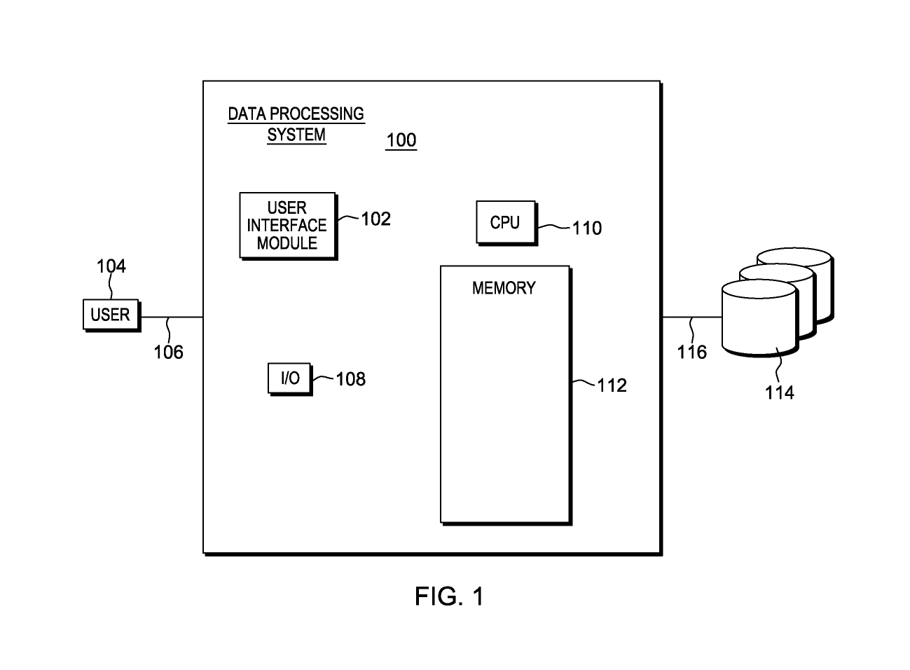

FIG. 1 depicts an example of a data processing system for facilitating one or more aspects of the present invention. Data processing system 100 is provided, in one aspect, for facilitating quantitative assessment of real estate property. Data processing system 100 includes a user interface module 102 to provide a user interface through which a user 104 interacts with data processing system 100. In one example, data processing system 100 comprises a web server and provides a web-interface for user 104 to connect-to via one or more data communications links 106. Data communications links 106 can be any appropriate wired or wireless communication channel that supports analog or digital communication of data between user 104 and data processing system 100. Examples include Ethernet, cable, and/or fiber-based communications links passing data packets between user 104 and data processing system across one or more networks such as the Internet. Data processing system 100 also includes one or more I/O components 108 for facilitating data input/output to and from data processing system 100, and more specifically in this example for facilitating communication of data with user 104. It should be understood that user 104 can refer to a physical user and/or one or more computer systems which, under direction and control of the user, can be used to interact with data processing system 100.

Data processing system 100 also includes one or more CPUs 110 which can execute one or more instructions for causing the data processing system to perform functions. In one example, CPU 110 executes an operating system and a web-server program for hosting a web-interface for user interaction therewith. Data processing system also includes memory 112 which, in one example, stores the one or more instructions executed by CPU 110, and other data.

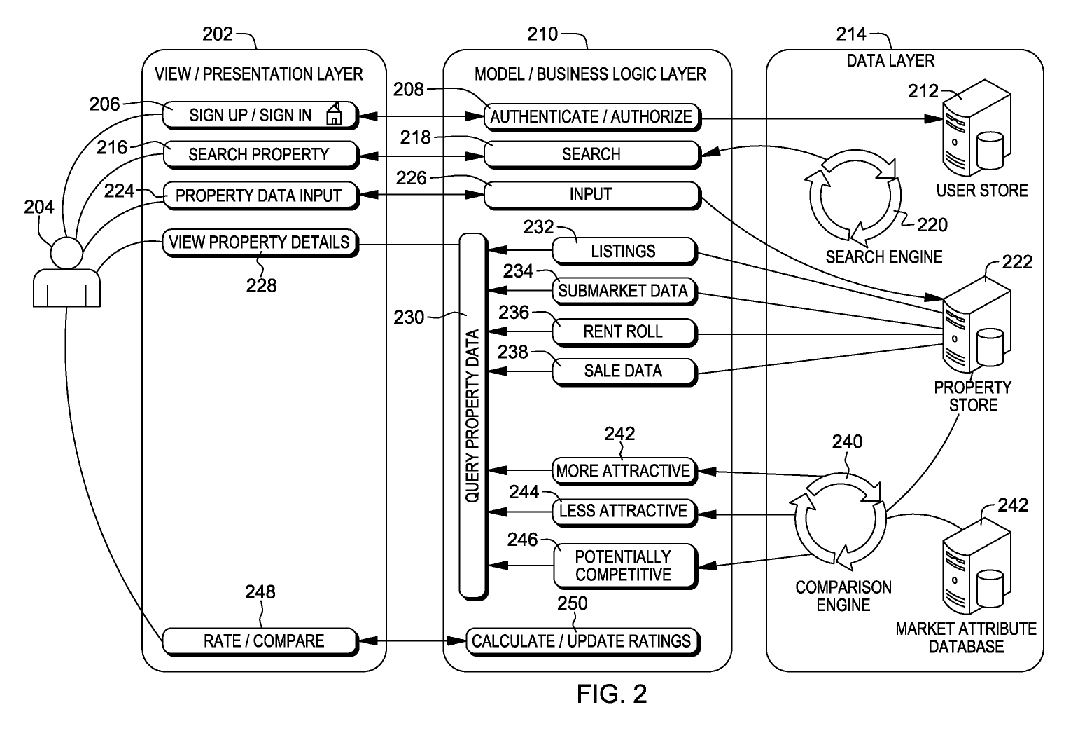

In the example of FIG. 1, data processing system 100 is in communication with one or more databases 114 across one or more data communications links 116. One or more databases 114 store data that can be used and/or accessed by data processing system 100. In one example, data processing system 100 stores and retrieves data from databases 114 responsive to request(s) and/or other interactions between user 104 and data processing system 100, as will be described in further detail below with reference to FIG. 2.

It should be understood that while FIG. 1 depicts a single data processing system, multiple data processing systems may be provided for facilitating aspects of the present invention. For instance, the functions of data processing system 100, described in connection with FIG. 2 and elsewhere herein, can be implemented in a computing environment that comprises multiple data processing systems, for instance each specializing in an assigned function or functions, as will be appreciated by those having ordinary skill in the art.

FIG. 2 depicts an overview of the architecture for facilitating one or more aspects of the present invention. Those having ordinary skill in the art will recognize that certain features of FIG. 2, which are described below, may be implemented in hardware, software, or a combination of the two. The overview architecture of FIG. 2 is provided to facilitate explanation of certain capabilities of a system and method for facilitating providing quantitative assessment of real estate property, in accordance with aspects of the present invention.

The architecture depicted in FIG. 2 is divided into architecture layers. Generally, the connections illustrated between different layers illustrate data flow between components of the layers.

In FIG. 2, view/presentation layer corresponds to one or more interfaces provided to a user 204 and through which user 204 interacts with the architecture. In one example, the one or more interfaces are provided in the form of a website which is served to user 204 via a network, for instance a local, or a wide area network such as the Internet.

Presentation layer 202 includes a sign up/sign in component 206. In one embodiment, sign in/sign up component 206 enables user 204 to sign up to use the real estate property assessment service and provide and retrieve assessments of properties entered into the system, should user 204 not already be registered. Registration to use the service can be effected via a sign-up/registration interface through which user 204 provides information and login credentials which are used to uniquely identify user 204 from other users. In one embodiment, user 204 may be charged a fee, such as a subscription or use-based fee, for being permitted access to the system and to provide/retrieve assessments of properties.

Regardless whether user 204 is registering (signing up) to use the service, or is signing-in (having already been registered), user 204 uses sign up/sign in component 206 to supply credentials for authentication with the system. Authentication is accomplished by way of authenticate/authorize component 208, depicted, in this example, within the model/business logic layer 210. Authenticate/authorize component 208 accesses a user store 212 in data layer 214 in order to authenticate the user by comparing the user-supplied credentials with those stored in user store 212. User store 212 may be, in one example, a database, such as a database 114 of FIG. 1, storing encrypted user credentials to facilitate user authentication.

After authenticating with the system, or, alternatively, in an embodiment where authentication is not a requirement, user 204 can perform a search for particular properties for comparison to each other using search property component 216. A user-initiated property search via search property component 216 invokes search module 218 which in turn invokes search engine 220 to perform a search in property store 222 for properties deemed possibly relevant to user 204's property search request. Property store 222 comprises, in one example, a database (such as a database 114 from FIG. 1). Property store 222 includes an index of real estate properties and stores information associated with each of the real estate properties. Example of such store data includes, but is not limited to, transaction data associated with the property (e.g. lease and sale data), as well as qualitative and quantitative assessment data of the properties made by users across comparison criteria, as will be explained in further detail below.

In one example, where a particular property is not already existent in property store 222, the user can be presented with a property data input interface 224 for inputting details about the particular property into the system. Property data input 224 can include, in one example, a form into which user 204 enters vital property data (such as street address) of the property which gets accepted into the property store via input component 226. In another example, property data input 224 comprises an uploader interface that enables a user to upload a particular file or import data from another software program or module, via the interface, which file or other data contains data that input component 226 can extract to identify one or more properties to add to property store 222.

After a user identifies a subject property, for instance after performing a search for the subject property or after inputting property data of the subject property to enter the subject property as a new property in property data store 222, the user can invoke a view property details component 228 in order for the system to display property details of the subject property. Responsive to selection by user 204 to view property details of a subject property, property store 222 may be queried by query component 230 to retrieve property data about the subject property. Property data can include (but is not limited to): listings data 232, submarket data 234, rent roll data 236, and sale data 238, as well as other information such as address information, and a photograph of the subject property. Listings data can comprises one or more of sale and/or lease information on a property that is for sale or lease, or any derivative of a sale or lease transaction, such as a lease-back. Submarket data can comprise information on the properties or transactions, such as sale or lease, that occur within a particular submarket. A market can include a specific geographical region that differs from other regions, for instance regions of a political map, such as Los Angeles County, or The City of San Diego. A submarket is, in one example, one unit of many that make up a market, such as Downtown Los Angeles, South Bay, Century City, or West Los Angeles. Rent Roll Data can include information pertaining to the past and/or current leases of tenants related to a specific property, and sale data can include the information pertaining to a specific sale transaction of a specific property, as examples.

Additionally, upon selection of the subject property to view details thereof, a comparison engine 240 can query the property store 222 and a market attribute database 242 in order to identify other properties known to the system, such as competitive properties, that exist in the same market as the subject property. In the specific example of FIG. 2, market attribute database 242 comprises a ZIP code database, whereby the ZIP code of the subject property is one (but perhaps not the only) market attribute used for defining the market of properties to which the subject property is compared when viewing property details. Comparison engine 240 retrieves properties from property store 222, which, in this example, are located within the same ZIP code as the subject property (or in some set of ZIP codes used to define the market), and provides details of these comparison properties back to user 204. For instance, more attractive property component 242, less attractive property component 244, and potentially competitive property component 246 return properties that are more attractive, less attractive, and potentially competitive, respectively, as compared to the subject property. Potentially competitive refers to a property that may have an attractiveness that is comparable to the subject property, for instance that may have an attractiveness measure that is within a defined range of the attractiveness of the subject property. Attractiveness may be based on qualitative and quantitative assessments of the subject property as compared to a comparison property, as will be described in further detail below.

Additionally, rate/compare component 248 is presented to user 204 for rating, in a qualitative manner, a subject property as compared to a comparison property. In one example, responsive to a user search for a property and presentation of the property details to the user, the user may qualitatively assess the subject property as compared to one or more comparison properties.

Using rate/compare component 248, and in accordance with one or more aspects of the present invention, a user can provide a qualitative assessment of the subject property. The qualitative assessment is a qualitative assessment of how the subject property compares to a comparison property, for instance a competitive property in the marketplace, and thus, comprises at least one qualitative comparison of the subject property to the comparison property. A qualitative comparison is a comparison of the subject property to the comparison property based on a comparison criterion. The collection of at least one qualitative comparison is thus a collection of one or more comparisons across one or more comparison criteria. The comparison criteria can include, but are not limited to, attractiveness criteria, such as levels of attractiveness of the property exterior, interior, location, amenities, ingress and/or egress, parking, and prestige, or other physical or perceived attribute or real estate. It should be recognized that other comparison criteria could be used, including any desired criterion against which a comparison can be made of one property to another property.

Each particular criterion is assessed using a qualitative comparison scale, which is presented to the user for selection of a qualitative comparison of the subject property to the comparison property for the particular comparison criterion. An example scale is provided in Table 1 below:

TABLE 1
Qualitative Comparison

| | | | | | | | |
|---|---|---|---|---|---|---|---|
| Excessively | Much Less | Less | Similar | More | Much More | Excessively | Don't |
| Less | Attractive | Attractive | | Attractive | Attractive | More | Know |
| Attractive | | | | | | Attractive | |

The example of Table 1 is just one example, and those having ordinary skill in the art will readily recognize many other qualitative comparison scales are possible.

For each comparison criterion of the comparison criteria, the user can select a corresponding qualitative comparison. As noted, the qualitative comparison is an assessment of how the subject property compares to the comparison property for a given criterion. So, selection by the user of the qualitative comparison “less attractive” for criterion “Parking” provides an indication that the subject property is “less attractive” than the comparison property in terms of parking By qualitatively assessing the subject property as compared to the comparison property across multiple criteria, each criterion being assessed by its own individual qualitative comparison provided by the user, a fine degree of granularity is enabled in the attractiveness comparison between the subject property and the comparison property. The collection of qualitative comparisons made by the user across one or more of the comparison criteria is termed a qualitative assessment, provided by the user, of the subject property as compared to the comparison property.

The qualitative comparisons on the scale of qualitative comparisons each represent a different level of attractiveness, ranging from excessively less attractive to excessively more attractive, in this example. In accordance with an aspect of the invention, each qualitative comparison is associated with a degree of attractiveness of the subject property as compared to the comparison property, and that degree of attractiveness can be represented as a numerical attractiveness value. The correlation between a qualitative comparison and a degree of attractiveness facilitates a translation of the qualitative assessment to a quantitative assessment, is be described in further detail below. Table 2 provides an example of the numerical attractiveness values associated with the qualitative comparisons shows in Table 1:

TABLE 2

| | Qualitative Comparison | | | | | | | |
|---|---|---|---|---|---|---|---|---|
| | Excessively | | | | | | Excessively | |
| | Less | Much Less | Less | | More | Much More | More | Don't |
| | Attractive | Attractive | Attractive | Similar | Attractive | Attractive | Attractive | Know |
| Attractiveness | −27 | −9 | −3 | 0 | +3 | +9 | +27 | (null) |
| Value | | | | | | | | |

As can be seen in Table 2, negative attractiveness values indicate a level of less-attractiveness of the subject property as compared to the comparison property, while positive attractiveness values indicate some level of more-attractiveness of the subject property as compared to the comparison property. When a user does not know or wishes to skip or otherwise not assess the subject property on a particular comparison criterion, the user can select “Don't Know”, in this example, as the qualitative comparison.

Also, as can be seen in Table 2, the scale of numerical attractiveness values need not be linear, in the sense of progressing along the scale from excessively less attractive to excessively more attractive. For instance, the difference between a “Similar” qualitative comparison (attractiveness value 0) and a “More Attractive” comparison, which is the next attractiveness grade better than “Similar”, indicates an attractiveness value difference of +3 (a jump from 0 to +3). Going one attractiveness grade better, from “More Attractive” (attractiveness value +3) to “Excessively More Attractive” (attractiveness value +27), indicates an attractiveness value difference of +24. Thus, the scale of degrees of attractiveness need not linearly increase with successive comparisons values, in this example. It should be noted that this is just one example of a degree of attractiveness scale, and that the scale may tailored with alternate values according to any particular scale desired.

In one example, rate/compare component 248 comprises a user interface for user 204 to qualitatively assess a subject property as compared to a comparison property. For instance, user 204 may be presented with one or more comparison criteria across which the subject property is to be qualitatively assessed by the user. For each criterion, the user may make a selection (e.g. via a radio button) to select a qualitative comparison from a scale of qualitative comparisons, such as described above, in order to provide a qualitative assessment of the subject property as compared to the comparison property. Responsive to the user providing the qualitative assessment, the assessment can be provided to the system (for instance data processing system 100 of FIG. 1), and more specifically to calculate/update ratings component 250 thereof, in order to calculate and/or update qualitative and quantitative assessments of the subject property in property store 222 (FIG. 2).

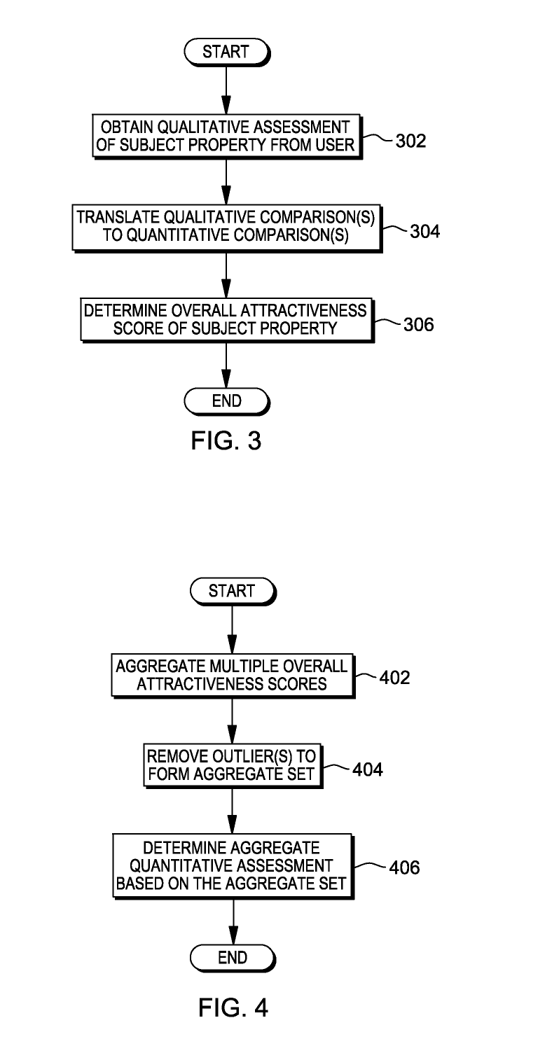

In accordance with one or more aspect of the present invention, quantitative assessment of a real estate property is provided. FIG. 3 depicts an example process for providing a quantitative assessment of a subject real estate property. The process of FIG. 3 can be performed, in one example, by a data processing system such as data processing system 100 of FIG. 1. Referring to FIG. 3, the process begins with the system obtaining a qualitative assessment of a subject property as compared to a comparison property (302). As described previously, the qualitative assessment may comprise one or more qualitative comparisons, for instance made by a user across one or more comparison criteria, and may be obtained from the user via a user interface provided by the data processing system. Next, the one or more qualitative comparisons of the qualitative assessment are translated to quantitative comparisons (304). In one example, this includes translating by the data processing system each of the qualitative comparisons to their respective attractiveness value (see Table 2 as an example), to obtain one or more quantitative comparisons. For instance, for each comparison criterion, the qualitative comparison selected by the user can be translated to its associated attractiveness value. In this regard, the system can be configured with the appropriate attractiveness values associated with the qualitative comparisons, in order to properly translate the qualitative comparisons. This configuration may be supplied by an administrator of the system, in one example. If the user selected “Don't Know” for a qualitative comparison, that can be translated to a null value and discarded or otherwise not taken into further consideration.

The collection of attractiveness values that are obtained responsive to translating the qualitative comparisons defines a collection of numerical attractiveness values. The process then determines from this collection an overall attractiveness score for the subject property as compared to the comparison property (306). The overall attractiveness score thus forms a quantitative assessment of the subject property as compared to the comparison property. In one particular example, the overall attractiveness score is determined by computing an average value of the collection of numerical attractiveness values. However, in other examples, a weighted average can be computed, wherein different attractiveness values are weighted differently (effectively giving different weights to different comparison criteria). For instance, it may be desired to weigh the exterior and amenity comparison criteria higher than the parking criterion, in one example, in which case the attractiveness values corresponding to the selected exterior and amenity qualitative comparisons are weighted more than the attractiveness value corresponding to the selected parking qualitative comparison, in the computation of the overall attractiveness score.

The process of FIG. 3 can be repeated for many users, wherein multiple quantitative assessments are obtained from the many users in comparing the subject property to the comparison property. Similarly, the process can be repeated by the many users to compare the subject property to other comparison properties. The qualitative and quantitative assessments obtained as a result can be stored in a database, such as a property store database (222 of FIG. 1; 114 of FIG. 1), as discussed earlier.

When multiple quantitative assessments have been obtained for a subject property as compared to a particular comparison property, an aggregate quantitative assessment of the subject property as compared to the comparison property can be determined. FIG. 4 depicts an example process for determining an aggregate quantitative assessment of a subject property, in accordance with one or more aspects of the present invention. First, the multiple quantitative assessments, and the overall attractiveness scores thereof, are aggregated (402). Next, outlier(s) can be removed to form an aggregate set of overall attractiveness scores (404). Numerous techniques are known for identifying outliers from a set of data. In one example, outlier overall attractiveness score can be identified as any overall attractiveness score that is a specified number of standard deviations from the mean of the aggregated overall attractiveness scores. The specified standard deviation can be specified by an administrator as an indication of how sensitive the model should be to deviations about the mean overall attractiveness score, when the system determines an aggregate quantitative assessment of the subject property. A typical specified standard deviation may be in the range of about 1.5-2, but this number could be lower or higher depending on the desired sensitivity. In one example (not depicted), no outliers are removed, and instead all of the aggregated overall attractiveness scores form the aggregate set.

Once outlier(s) are removed and the aggregate set of overall attractiveness scores is formed, the process determines an aggregate quantitative assessment based on this aggregate set of overall attractiveness scores (406). In one example, the aggregate quantitative assessment is determined by computing the average of the overall attractiveness scores that form the aggregate set of overall attractiveness scores. Thus, in this example, the aggregate quantitative assessment is the mean of overall attractiveness scores from the multiple quantitative assessments, but with outliers removed. This aggregate quantitative assessment can also be stored in property store 222 along with the other assessment data of the subject property to the comparison property

In accordance with a further aspect of the present invention, a predictive quantitative assessment of a subject property as compared to a target comparison property can be determined. This can be useful in the situation where qualitative assessment(s) comparing the subject property to a first comparison property and qualitative assessment(s) comparing the target comparison property to the first comparison property have been obtained, but where users have not have provided qualitative assessment(s) comparing the subject property directly to the target comparison property. In accordance with this aspect of the present invention, the predictive quantitative assessment for how a subject property compares to a target property is determined based on how users have assessed the subject and target properties against a common comparison property.

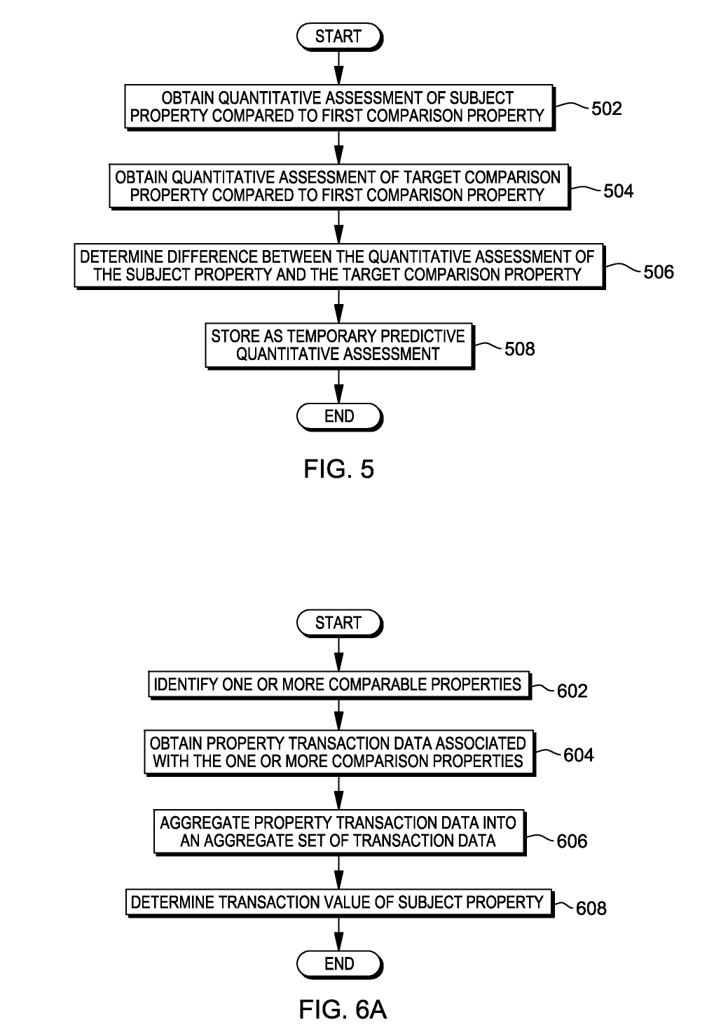

FIG. 5 depicts an example process for determining a predictive quantitative assessment for a subject property. The process begins by obtaining a quantitative assessment of the subject property as compared to a first comparison property (502) and obtaining a quantitative assessment of the target comparison property as compared to the first comparison property (504). In one example, the two quantitative assessments obtained are determined from two qualitative assessments provided by a user, and thus the predictive quantitative assessment for the subject property is determined on a relatively micro (single-user) scale. In another example, the two quantitative assessments are taken on a macro (aggregate) scale and instead comprise aggregate quantitative assessments—one for the subject property as compared to the first comparison property and the other for the target property as compared to the first comparison property—and thus, in this situation, each obtained assessment was determined from multiple quantitative assessments by many users, as described above with reference to FIG. 4.

Next, a difference is determined between the quantitative assessment of the subject property as compared to the comparison property and the quantitative assessment of the target property as compared to the comparison property (506). This difference can be simply the difference between the overall/aggregate attractiveness scores of the two assessments. For instance, if the aggregate quantitative assessment of the subject property as compared to the first comparison property indicates +3 in aggregate overall attractiveness, and the aggregate quantitative assessment of the target property as compared to the first comparison property indicates −1 in aggregate overall attractiveness, then this difference is 4. Since the subject property is indicated as being 3 units of attractiveness more attractive than the first comparison property, and the target comparison property is indicated as being 1 unit of attractiveness less attractive than the first comparison property, then by association, the subject property is determined to be 4 units more attractive (+4) than the target comparison property. This +4 value can then be stored as a temporary predictive quantitative assessment of the subject property as compared to the target comparison property.

In the example above, the temporary quantitative assessment is predictive in the sense that it is determined based on how they compare to a common property, but which have not themselves been compared to each other. Later, responsive to one or more users providing one or more qualitative assessments to the system and the system determining one or more quantitative assessments therefrom, the temporary predictive quantitative assessment can be replaced by the actual quantitative assessment(s) derived from the direct comparison(s) by the users. Different techniques can be used to effect this replacement. For instance, in one example, the temporary predictive quantitative assessment can be stored until a particular number of quantitative assessments comparing the subject property to the target comparison property have been determined, at which point the temporary predictive quantitative assessment can be replaced with the quantitative assessments and/or an aggregate quantitative assessment determined therefrom. Alternatively, the temporary predictive quantitative assessment stored initially can be an initial quantitative assessment that is adjusted, for instance by weight-based averaging, as user-provided qualitative assessments are obtained and translated by the data processing system into quantitative assessments. In this latter example, the temporary predictive quantitative assessment becomes phased out of the aggregate quantitative assessment of the subject property as compared to the target property by decreasing the weighted contribution of the predictive quantitative assessment to the aggregate quantitative assessment. Eventually the predictive quantitative assessment contributes very little to the aggregated quantitative assessment, or can be phased-out of the determination altogether.

In accordance with a further aspect of the present invention, a comparative model is used to analyze transaction data of properties comparable to a subject property and create hypothetical values of the subject property, for instance based on the mean of the transaction data of the comparison properties. In one example, transaction data such as, but not limited to, lease and sale data, is used to determine a quantitative value, or Market Value, of the subject property for display to a user.

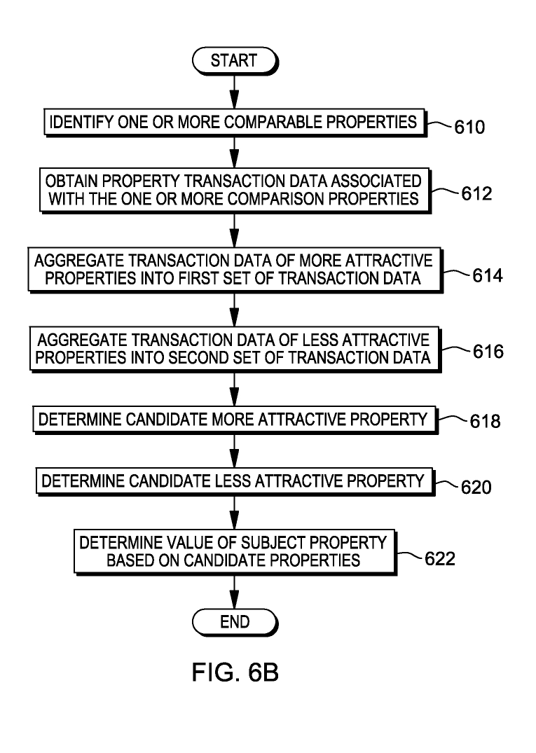

FIGS. 6A & 6B provides example processes for valuing a subject property. The subject property could comprise a property selected by a user, for instance responsive to a property search described above with reference to FIG. 2. Alternatively, the subject property may be one identified by the system, absent user participation, for instance as part of a background process, as being a property that does not have up-to-date (as defined by a window of time) transaction data associated with it.

Referring for FIG. 6A, one or more properties comparable to the subject property are identified (602). For instance, the system identifies one or more comparison properties that have an aggregate quantitative assessment as compared to the subject property that is within a particular numerical range. By way of specific example, the system might identify those comparison properties where the aggregate quantitative assessment of the comparison property to the subject property, or the aggregate quantitative assessment of the subject property to the comparison property, is between −3 and +3. Additionally or alternatively, the identified properties can be narrowed based on those properties having transaction data from within a particular time period, for instance within the past year. Additionally or alternatively, the identified properties can be further limited according to at least one additional limiting criterion. These additional limiting criteria could be one or more of: geographic location (e.g. distance between subject property and comparable property), ZIP code, class of building, submarket, and/or building or property size, as examples.

The identified comparison properties can be displayed for the user, in one embodiment. In a further embodiment, the comparison properties can be sorted within that display according to a qualifier. The qualifier could comprise the aggregate quantitative assessment of the subject property as compared to the identified properties, wherein the closest less attractive and closest more attractive comparable properties are displayed first. Alternatively or additionally, the comparison properties could be sorted based on a particular comparison criterion, for instance sorted by those comparable properties being closest in attractiveness for the criterion of Amenities. Alternatively or additionally, the comparison properties could be sorted according to whether the comparison property is for sale or available, for instance displaying first those properties that are for sale or available.

Continuing with FIG. 6A, property transaction data associated with the one or more comparison properties is obtained (604) and aggregated into an aggregate set of transaction data (606). As before, the aggregating can optionally include exclusion of outlier data from the aggregate set, for instance by using a statistical normal distribution curve to determine a mean transaction value and then removing transaction data not within a specified number of standard deviations of the mean transaction value. Then, a transaction value of the subject property can be determined (608). For instance, the mean of the aggregate set of transaction data is computed by the system, or the system identifies a range of transaction values which may affect the transaction or perceived value of the subject property.

FIG. 6B depicts an alternate process for valuing a subject property. As in FIG. 6A, FIG. 6B begins with identification of one or more properties comparable to the subject property (610), and obtaining property transaction data associated with the one or more comparison properties (612). Next, transaction data of those comparable properties that are considered more attractive, as measured by, for instance, aggregate quantitative assessment of the subject property to the comparison property, are aggregated into an aggregate first set of transaction data (614). Additionally, transaction data of those comparable properties that are considered less attractive, as measured by, for instance, aggregate quantitative assessment of the subject property to the comparison property, are aggregated into an aggregate second set of transaction data (616). Similar to above, the aggregating of the first set and the aggregating of the second set can optionally include exclusion of outlier data from the aggregate sets, for instance by using a statistical normal distribution curve to determine a mean transaction value of these more attractive (or less attractive, as the case may be) properties, and then removing transaction data not within a specified number of standard deviations of that mean transaction value.

In aggregating the first set and the second set, the transaction values of the more attractive properties (as compared to the subject property) are grouped together, and the transaction values of the less attractive properties (as compared to the subject property) are grouped together. From there, a candidate more attractive property can be determined from the aggregate first set of transaction data (618), and a candidate less attractive property can be determined from the aggregate second set of transaction data (620). In determining a candidate property from a particular aggregate set, an average transaction value of the properties in that particular set can be determined, and the candidate property from the set can be determined based on that mean. In one example, it could be the property with the transaction value that is closest to this mean of the transaction values that make up that set.

To illustrate the above, assume that properties M1, M2, and M3 are identified as the most comparable more attractive properties as compared to the subject property, and that properties L1, L2 and L3 are identified as the most comparable less attractive properties as compared to the subject property. Assume transaction values as follows: M1: $110,000; M2: $117,000; M3: $120,000; L1: $90,000; L2: $85,000; L3: $80,000, and assume aggregate quantitative assessment of the subject property to each of the comparable properties as follows: M1: (−3); M2: (−8); M3: (−10); L1: (+1); L2: (+3); L3: (+5).

Using the above example, the aggregate first set F={$110,000, $117,000, $120,000} and the aggregate second set S={$90,000, $85,000, $80,000}. The mean transaction value of aggregate set F (more attractive properties)=$115,666.66, while the mean transaction value of aggregate set S=$85,000 (assuming no outliers are removed).

In this example, if the candidate more attractive property is defined to be the property with the transaction value that is closest to the mean transaction value, then property M2 having transaction value $117,000 is selected, since its transaction value is closest to the mean transaction value ($115,666.66) of more attractive properties. Similarly, the candidate less attractive property would be property L2, having transaction value of $85,000, which is equal to the mean transaction value of less attractive comparable properties.

In another example, the candidate property could be defined differently. Since a more attractive property is expected to have a higher transaction value than a less attractive property, and a less attractive property is expected to have lower transaction value than a more attractive property, the transaction value for the subject property, which is what is being predicted here, is expected to be less than the mean transaction value of the more attractive properties, but more than the mean transaction value of the less attractive properties. Thus, it may be beneficial to select as the candidate more attractive property that property which has a transaction value that is closest to the mean transaction value for the more attractive properties without exceeding (being greater than) that mean transaction value for the more attractive properties. Similarly, it may be beneficial to select as the candidate less attractive property that property which has a transaction value that is closest to the mean transaction value for the less attractive properties without being less than that mean transaction value for the less attractive properties. To illustrate using the above example, the candidate more attractive property would not be M2, having transaction value $117,000 (closest to mean $115,666.66), but instead would be M1, which has the closest transaction value ($110,000) without exceeding the mean of $115,666.66, while the candidate less attractive property would again be L2.

In any case, once the candidate more attractive property and candidate less attractive properties are determined, a value of the subject property can be determined based on these candidate properties. In one example, the transaction value of the subject property is determined to be the average of the transaction value of the candidate more attractive property and the transaction value of the candidate less attractive property. In the example above, and using M2 and L2 as the candidate more attractive and less attractive properties, respectively, the value of the subject property would be ($117,000+$85,000)/2=$101,000.

In another example, the transaction value of the subject property is determined based not only on transaction values of the candidate properties but also on a comparison of the difference in attractiveness of the subject property as compared to the candidate more attractive property and as compared to candidate less attractive property. For instance, in the example above, and again using M2 and L2 as the candidate more attractive and less attractive property, the difference in attractiveness between the subject property and the more attractive property is 8 units (the aggregate quantitative assessment of the subject property as compared to M2 is −8). Meanwhile, the difference in attractiveness between the subject property and the less attractive property is 3 units (the aggregate quantitative assessment of the subject property as compared to L2 is +3). These differences can be used as weights in estimating a transaction value for the subject property. For instance, the transaction value of the more attractive property M2 ($117,000) can be weighted 8, while the transaction value of the less attractive property L2 ($85,000) can be weighted 3. The weighted average can then be determined to estimate the transaction value of the subject property: (8/11)*$117,000+(3/11)*$85,000=$85,090.91+$23,181.82=$108,272.73. Hence, in the above example, the transaction value of the subject property is a function not only of transaction values of comparable properties, but also the degree to which those properties are more attractive or less attractive than the subject property.

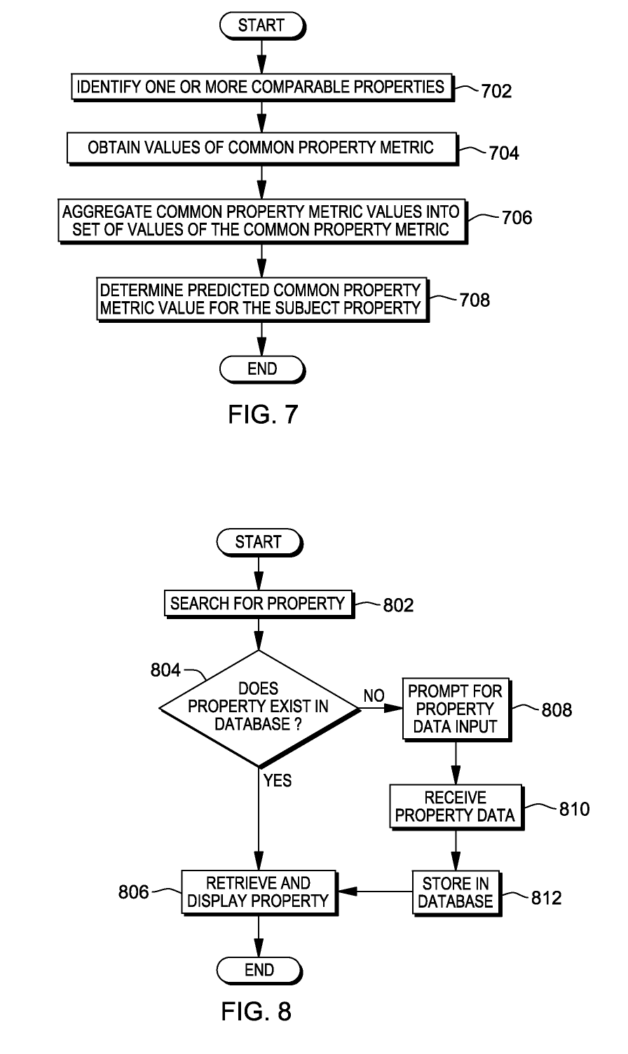

As noted above, in one example the transaction data comprises, for instance, property sale or lease price, and an estimated transaction value for the subject property can be determined. In another example, instead of transaction data, the system can obtain values for one or more metrics common to the comparable properties and the subject property, and the system could predict a value for the common property metric for the subject property. As an example, the common property metrics could include the comparison criteria across which the properties are qualitatively assessed by the users, and the value of the common property metric could be a degree of attractiveness for the associated comparison criterion. FIG. 7 depicts one example of a process for determining a predicted common property metric value for a subject property. The process begins, as above, with identification of one or more properties comparable to the subject property (702). Next, values of a common property metric are obtained for the one or more comparison properties (704). In one example, for each of the comparison properties, the determined degree of attractiveness (as compared to the subject property) for the common property metric is obtained for each of the comparison properties. In one example, this degree of attractiveness could be an average of all degrees of attractiveness determined from the qualitative assessments obtained from the users in comparing the subject property to the comparison property. Then, the common property metric values are aggregated into a set of values of the common property metric (706), and again optionally eliminating outlier values if desired. Lastly, a predicted common property metric value for the subject property can be determined. In one example, the predicted value is an average of the aggregated set of values. Alternatively, the predicted value could be determined using the technique described above where not only the values of comparable properties, but also the degree to which those properties are more attractive or less attractive than the subject property are incorporated into this determination.

As described above in connection with FIGS. 1 and 2, a user can search and retrieve a property for comparison to one or more other properties. As part of this retrieval process, the user may be prompted to enter property information into the system for the particular property searched for, should that property not yet exist as a property in the system. FIG. 8 depicts one example of such a process for retrieving a property for comparison. In one embodiment, the process is performed by a data processing system, such as data processing system 100 of FIG. 1. The process begins with a user search/query (802). This search could be for a particular property of interest, or may be a more generalize search, for instance for properties located within a specified distance of a particular location, within a particular geographic market, etc. Responsive to the search, the system determines whether a property or properties exist in the system (for instance property store 222 of FIG. 2) that satisfy that query (804). If so, the property or properties are retrieved and displayed for the user (806). From there, the user can continue interacting with the system, for instance to provide a qualitative assessment of the property, or to display a predictive quantitative assessment or transaction or other values associated with the subject property. If however, the property or properties do not exist in the system, then the user can be prompted to input property data of the property (808). In one example, a property data input module (e.g. 224 of FIG. 2) is displayed to the user. The user can then input details about the particular property into the system. The system receives the property data (810) and stores this in the database (e.g. property store 222) (812). The property data is then retrieved and displayed for the user (806). From there, the user can continue interacting with the system, as above.

In accordance with another aspect of the invention, the system can track which users have provided qualitative assessments, property information, and/or transactional information of which subject properties, including how many properties have been assessed by which users. This can provide an indication of which users have the greatest knowledge of a subject property. In one embodiment, the system aggregates the number of comparisons a specific user, for instance a specified user specified by an administrator of the system, completes in a specific market. The market could be defined by a geographic area, ZIP code, property value, as examples. The system can be configured to display which users have completed the highest number of comparisons, in one example.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

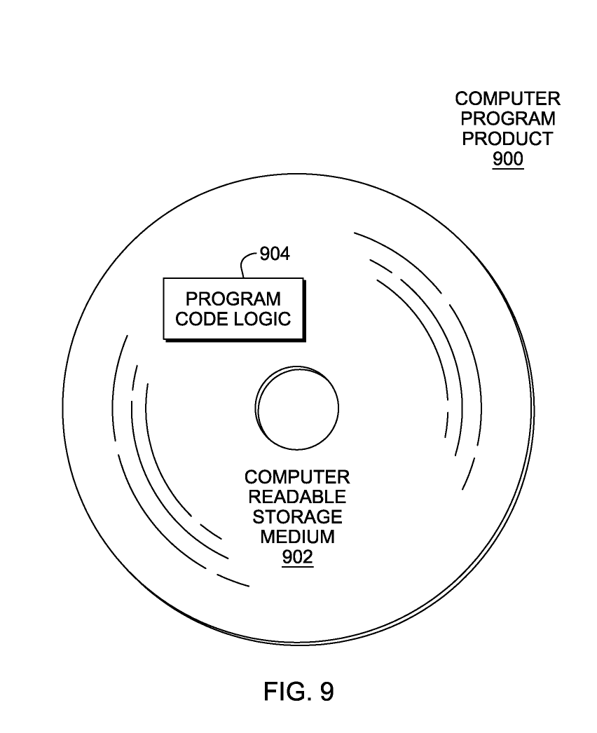

Referring now to FIG. 9, in one example, a computer program product 900 includes, for instance, one or more computer readable media 902 to store computer readable program code means or logic 904 thereon to provide and facilitate one or more aspects of the present invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiment with various modifications as are suited to the particular use contemplated.

What is claimed is:

1. A method for providing quantitative assessment of real estate property, the method comprising:
obtaining from a user, by a data processing system, a qualitative assessment of a subject property as compared to a comparison property via a user interface provided by the data processing system, the qualitative assessment comprising at least one qualitative comparison of the subject property to the comparison property for at least one comparison criteria; and
determining, based on the obtained qualitative assessment, a quantitative assessment of the subject property as compared to the comparison property, the quantitative assessment comprising an overall attractiveness score of the subject property as compared to the comparison property, the determining comprising:
translating the at least one qualitative comparison into at least one quantitative comparison of the subject property to the comparison property, to obtain at least one numerical value; and
determining the overall attractiveness score based on the obtained at least one numerical value.

2. The method of claim 1, wherein each qualitative comparison of the at least one qualitative comparison is selected for a different respective comparison criterion of the at least one comparison criteria from a plurality of possible qualitative comparisons associated with different degrees of attractiveness of the subject property as compared to the comparison property.

3. The method of claim 2, wherein the degrees of attractiveness comprise numerical attractiveness values, and wherein the translating comprises translating each selected qualitative comparison into a respective numerical attractiveness value of the numerical attractiveness values, to obtain the at least one numerical value.

4. The method of claim 3, wherein determining the overall attractiveness score comprises averaging the at least one numerical value.

5. The method of claim 1, wherein the at least one comparison criteria comprise at least one of location, exterior, interior, amenities, ingress/egress, parking, prestige, or another physical or perceived attribute of real estate.

6. The method of claim 1, wherein the method further comprises:
repeating the obtaining and the determining to obtain at least one other quantitative assessment of the subject property as compared to the comparison property, wherein the obtaining and the determining are repeated for at least one other qualitative assessment of the subject property by at least one other user; and
determining an aggregate quantitative assessment of the subject property as compared to the comparison property based on the quantitative assessment and the at least one other quantitative assessment.

7. The method of claim 6, wherein the determining the aggregate quantitative assessment comprises:
aggregating overall attractiveness scores from the quantitative assessment and the at least one other quantitative assessment into an aggregate set of overall attractiveness scores, wherein the aggregating comprises excluding from the aggregate set outlier overall attractiveness scores that are not within a particular number of standard deviations of a mean of the overall attractiveness scores from the quantitative assessment and the at least one other quantitative assessment; and
determining the aggregate quantitative assessment from the aggregate set of overall attractiveness scores, wherein determining the aggregate quantitative assessment comprises determining a mean overall attractiveness score from the aggregate set of overall attractiveness scores.

8. The method of claim 1, wherein the comparison property comprises a first comparison property, and wherein the method further comprises determining a predictive quantitative assessment of the subject property as compared to a target comparison property, the determining the predictive quantitative assessment comprising:
obtaining the quantitative assessment of the subject property as compared to the first comparison property;
obtaining a quantitative assessment of the target comparison property as compared to the first comparison property; and
determining a difference between the quantitative assessment of the subject property as compared to the first comparison property and the quantitative assessment of the target comparison property as compared to the first comparison property, wherein the difference indicates the predictive quantitative assessment of the subject property to the target property.

9. The method of claim 8, further comprising:
storing the predictive quantitative assessment as a temporary quantitative assessment, the temporary quantitative assessment to be replaced upon direct comparison of the subject property to the target comparison property by a user; and
responsive to obtaining a qualitative assessment of the subject property as compared to the target comparison property by a user:
determining, based on the obtained qualitative assessment, a quantitative assessment of the subject property as compared to the target comparison property; and
replacing the stored predictive quantitative assessment with the determined quantitative assessment of the subject property as compared to the target comparison property.

10. The method of claim 1, further comprising identifying at least one comparable property, comparable to the subject property, based on one or more quantitative assessments of the subject property as compared to the at least one comparable property, wherein the identifying limits the at least one comparable property to those properties comprising an aggregate quantitative assessment as compared to the subject property to within a particular numerical range.

11. The method of claim 10, further comprising valuing the subject property, the valuing comprising:
obtaining property transaction data associated with the at least one comparable property;
aggregating the transaction data into an aggregate set of transaction data, wherein the aggregating comprises excluding from the aggregate set outlier transaction data that are not within a particular number of standard deviations of a mean of the transaction data associated with the at least one comparable property; and
determining a transaction value from the aggregate set of transaction data, wherein determining the transaction value comprises determining a mean transaction value from the aggregate set of transaction data.

12. The method of claim 10, further comprising valuing the subject property, the valuing comprising:
obtaining property transaction data associated with the at least one comparable property;
aggregating, into an aggregate first set of transaction data, transaction data associated with properties of the at least one comparable property considered more attractive than the subject property, measured by aggregate quantitative assessment of the subject property as compared to the more attractive properties, wherein outlier transaction data not within a particular number of standard deviations of a mean of the transaction data associated with those more attractive properties are excluded;
aggregating, into an aggregate second set of transaction data, transaction data associated with properties of the at least one comparable property considered less attractive than the subject property, measured by aggregate quantitative assessment of the subject property as compared to the less attractive properties, wherein outlier transaction data not within a particular number of standard deviations of a mean of the transaction data associated with those less attractive properties are excluded;
determining which more attractive comparable property of the more attractive properties has a transaction value that is closest in value to the mean of the aggregate first set of transaction data;
determining which less attractive comparable property of the less attractive properties has a transaction value that is closest in value to the mean of the aggregate second set of transaction data; and
determining a value of the subject property based on the transaction value of the determined more attractive comparable property and the transaction value of the determined less attractive comparable property.

13. The method of claim 12, wherein the value of the subject property is determined based on a comparison of the difference in attractiveness between the subject property and the less attractive comparable property with the difference in attractiveness between the subject property and the more attractive comparable property.

14. The method of claim 10, wherein the identifying further limits the at least one comparable property according to at least one additional limiting criterion, and wherein the at least one additional limiting criterion comprises at least one of geographic location; zip code; building class; submarket; and building size.

15. The method of claim 14, wherein the method further comprises:
obtaining transaction data of the at least one comparable property, the transaction data comprising values of a common property metric across the at least one comparable property;
aggregating the values of the common property metric into an aggregate set of values of the common property metric, wherein the aggregating comprises excluding from the aggregate set outlier values of the common property metric that are not within a particular number of standard deviations of a mean of the values of the common property metric across the at least one comparable property; and
determining a predicted value of the common property metric for the subject property based on the aggregate set of values of the common property metric, wherein determining the predicted value comprises determining a mean property metric value from the values in the aggregate set of values of the common property metric.

16. The method of claim 1, further comprising tracking the number of qualitative assessments of one or more subject properties provided by one or more users, the one or more subject properties being associated with a specific property market, and displaying a list of users with the highest number of qualitative assessments of the one or more subject properties.

17. The method of claim 1, further comprising:
receiving a search request from the user, the search request comprising one or more queries to facilitate selection of the subject property; and
responsive to the subject property not existing as a subject property in the database of properties:
receiving from the user data about the subject property; and
storing the received data about the subject property in the database to enter the subject property therein for comparison to the comparison property.

18. The method of claim 17, further comprising providing a data input module for data input from the user to facilitate at least one of importing or inputting the data about the subject property into the data input module for storage into the database of properties.

19. A computer system for providing quantitative assessment of real estate property, the system comprising:
a memory; and
a processor in communications with the memory, wherein the computer system is configured to perform:
obtaining from a user, by the computer system, a qualitative assessment of a subject property as compared to a comparison property via a user interface provided by the data processing system, the qualitative assessment comprising at least one qualitative comparison of the subject property to the comparison property for at least one comparison criteria; and
determining, based on the obtained qualitative assessment, a quantitative assessment of the subject property as compared to the comparison property, the quantitative assessment comprising an overall attractiveness score of the subject property as compared to the comparison property, the determining comprising:
translating the at least one qualitative comparison into at least one quantitative comparison of the subject property to the comparison property, to obtain at least one numerical value; and
determining the overall attractiveness score based on the obtained at least one numerical value.

20. A computer program product for providing quantitative assessment of real estate property, the computer program product comprising:
a tangible storage medium readable by a processor and storing instructions for execution by the processor to perform a method comprising:
obtaining from a user, by a data processing system, a qualitative assessment of a subject property as compared to a comparison property via a user interface provided by the data processing system, the qualitative assessment comprising at least one qualitative comparison of the subject property to the comparison property for at least one comparison criteria; and
determining, based on the obtained qualitative assessment, a quantitative assessment of the subject property as compared to the comparison property, the quantitative assessment comprising an overall attractiveness score of the subject property as compared to the comparison property, the determining comprising:
translating the at least one qualitative comparison into at least one quantitative comparison of the subject property to the comparison property, to obtain at least one numerical value; and
determining the overall attractiveness score based on the obtained at least one numerical value.
